(19) United States
(12) Patent Application Publication
(10) Pub. No.: US 2006/0202575 A1
(43) Pub. Date: Sep. 14, 2006

(54) Hub dynamo

(75) Inventors: Kenji Itoi, Kiryu-shi, Gunma (JP); Hideyuki Minami, Kiryu-shi (JP); Takeshi Yoda, Kiryu-shi (JP); Ryuichi Takakusagi, Kiryu-shi (JP)

Correspondence Address: OLIFF & BERRIDGE, PLC, P.O. BOX 19928, ALEXANDRIA, VA, 22320, US

(73) Assignee: Mitsuba Corporation, Kiryu-shi, Gunma (JP)

(21) Appl. No.: 10/564,942

(22) PCT Filed: Jul. 21, 2004
(86) PCT No.: PCT/JP04/10743

§ 371 Date: Feb. 15, 2006

(30) Foreign Application Priority Data
Jul. 25, 2003 (JP) 2003-280057

(51) Int. Cl. H02K 7/18

(52) U.S. Cl. 310/75 C

(57) ABSTRACT

A hub dynamo is compacted into a small diameter size while ensuring the generation of a high voltage of electric power. A coil chamber formed between a pair of main iron 10 cores, is partitioned in the axial direction by at least one sub iron 11 core to form a plurality of coil chambers. On the coil chambers a coil wire is wound such that the winding direction changes alternately between adjacent coil chambers. Magnetic flux collectors are connected to the outer circumference of the main/sub iron cores and include a plurality of first magnetic flux 15 collectors connected with the odd numbered iron cores and a (counting from either end) and a plurality of second magnetic flux collectors connected with the even numbered iron cores cores.

This application is the U.S. National Stage of PCT/JP2004/010743, filed Jul. 21, 2004, which claims priority from JP2003-280057, filed Jul. 25, 2003, the entire disclosures of which are incorporated herein by reference thereto.

### BACKGROUND OF THE INVENTION

The disclosure pertains to a hub dynamo mounted on forks constituting a part of a frame of a bicycle.

Generally, some bicycles are provided with a dynamo on an axle attached to the forks constituting a part of the frame. With rotation of a wheel which accompanies traveling of the bicycle, electric power is generated and a headlamp lights up using the electric power generated thereby.

A hub dynamo, as an electric power generator, is required to provide a compact size and to ensure a high voltage without increasing the speed. For example, a dynamo as described below has been proposed. That is, at the inner circumference of the rotor (yoke) at the wheel side, permanent magnets are provided in a state that the magnetic polarity changes alternately in the peripheral direction and a stator at the axle side comprises a pair of iron cores, which are so-called claw pole type iron cores including a plurality of magnetic flux collectors (pole pieces) to obtain multipolarity, and a coil (coil wire wound between the iron cores) fitted inside these iron cores (for example, refer to Japanese Published Unexamined Patent Application No. 2991705).

In such a structure, to obtain sufficient generation of electric power even traveling at a slow speed, it is conceivable to arrange the dynamo to be a multipolarity type. However, to arrange the claw pole type dynamo to be a multipolarity type, the diameter thereof has to become larger in size to prevent magnetic saturation and armature reaction. Therefore, there arises a problem that the above conflicts with requests for a reduction in size and weight.

To solve the above problem, there has been proposed the following arrangement. That is, using a coil engaged on the inside thereof between a pair of claw pole type iron cores as a power-generating unit, the plurality of power generating units are juxtaposed with respect to the axle and the permanent magnets provided at the rotor side are elongated in the axial direction so as to face all of the plurality of power generating units. With such a structure, each of these power generating units is individually magnetized to generate the electric power (for example, refer to Japanese Published Examined Utility Model Application No. 2603339).

On the other hand, as a means for obtaining sufficient generation of electric power even traveling at a slow speed, it is conceivable to secure a large magnetic flux from the permanent magnets. There has been proposed the following arrangement. That is, a plurality of magnetic flux collectors, which are elongated in the axial direction. These magnetic flux collectors are connected with the outer circumference of a pair of iron cores formed of a ring-like plate member provided at both sides of the coil (for example, refer to Japanese Published Unexamined Patent Application No. Hei-11-34954).

The arrangement disclosed in Japanese Published Examined Utility Model Application No. 2603339 has the following problems. That is, many claw-pole type iron cores must be used in accordance with the number of power generating units resulting in an increase in the number of components and, accordingly, in the weight. To uniformly generate the electric power with each of the power generating units, it is indispensable to control the bending angle of the iron core members, the dimension of the pole pieces, warp of the plate members and the like. And further, high precision is required for the assembly thereof Furthermore, when a difference is generated in the distance (gap) between the permanent magnets and pole pieces facing each other, the balance of the electric power generation on each power-generating unit is largely lost.

### SUMMARY

In contrast, compared to Japanese Published Examined Utility Model Application No. 2603339, the arrangement disclosed in Japanese Published Unexamined Patent Application No. Hei-11-34954 has an advantage that the size can be reduced and the precision of the gap between the magnetic polarity and the magnets on the inner circumference of the yoke is increased. However, in this arrangement, the magnetic flux collectors are supported only by the outer circumference of the iron cores at the both sides of the axle. Therefore, there resides a problem that magnetic saturation is apt to easily occur at the supporting portion, and the supporting strength is insufficient. In all cases, improvement is required. These are the disadvantages that the disclosure intends to solve.

In view of the above-described problems, the following has been proposed to solve the disadvantages. The disclosure addresses one exemplary embodiment in which a hub dynamo for a bicycle, having a stator and a rotor, the stator fixed to axle side comprises a pair of main iron cores, each formed of a ring-like plate member, disposed at the stator ends to form a coil chamber therebetween; at least one sub iron core formed of a ring-like plate member and disposed between the pair of main iron cores to partition the coil chamber, the main iron cores and the at least one sub-iron cores making up a set of iron cores; a coil wire wound in the partitioned coil chambers; and magnetic flux collectors formed of a long member extending between the main iron cores, disposed in parallel with each other in the peripheral direction on the outer circumference of the iron cores, the magnetic flux collectors closely facing long permanent magnets disposed on the inner circumference of the rotor at the wheel side in a state that the magnetic polarity changes alternately in the peripheral direction, wherein a first magnetic flux collector of the magnetic flux collectors facing one magnetic polarity and a second magnetic flux collector facing the other magnetic polarity are connected to respective iron cores so as to magnetize adjacent iron cores to an opposite polarity from each other.

By arranging, as described above, the hub dynamo can be reduced in size and weight and, further, a high voltage generation of electric power is obtained. As a result, the loss relevant to the generation of electric power can be reduced and the efficiency in power generation can be increased. Additionally, by providing the main/sub iron cores connected with the magnetic flux collectors, the magnetic path can be shortened by employing a simple structure.

In another exemplary embodiment of a hub dynamo for a bicycle, having a stator and a rotor, the stator fixed to the axle side comprises a pair of main iron cores, each formed of a ring-like plate member, disposed at the stator ends to form a coil chamber; at least one sub iron core formed of a ring-like plate member and disposed between the pair of main iron cores to partition the coil chamber, the main iron cores and the at least one sub iron core making up a set of iron cores; a coil wire wound in the partitioned coil chambers; and magnetic flux collectors formed of a long member extending between the main iron cores, disposed in parallel with each other in the peripheral direction on the outer circumference of the iron cores, which closely face long permanent magnets disposed on the inner circumference of the rotor at the wheel side in a state that the magnetic polarity changes alternately in the peripheral direction, wherein a first magnetic flux collector of the magnetic flux collectors facing one magnetic polarity and a second magnetic flux collector facing the other magnetic polarity are connected to the respective iron cores so as to magnetize the adjacent iron cores to an opposite polarity from each other, magnetic paths for the adjacent coil chambers partitioned by the at least one sub iron core are formed by the at least one sub iron core.

By arranging as described above, a well-balanced magnetic flux can be generated in each coil chamber and a hub dynamo superior in generating electric power can be obtained.

Further, in either of the exemplary embodiments, the first magnetic flux collector is arranged to be connected to the main iron core at one end side of the axle and to every other iron core moving away from the side main iron core, the second magnetic flux collector is arranged to connect to the iron cores unconnected to the first magnetic flux collector. Owing to this arrangement, a plurality of connection points between the magnetic flux collectors and the iron cores is ensured and magnetic saturation can be reduced.

Additionally, in the exemplary embodiments, the coil wire wound in each coil chamber can be arranged so that the directions of the winding wires in adjacent coil chambers are opposite each other. Thus, it is not necessary to form a troublesome wiring circuit for the coil wire.

Further, where the coil wire wound in each coil chamber is continuously wound in order from the coil chamber at the end side in the axial direction, separate circuits for connecting the coil wires from the coil chambers are not required. Thereby, the structure can be simplified and compacted.

In addition, the magnetic flux collectors are fixed to projecting pieces formed on the outer circumference of each iron core in a manner of caulking. Owing to this arrangement, the magnetic flux collector and the main/sub iron cores can be formed by press working which reduces costs. In such a case, on the outer circumference of each iron core, concave portions and convex portions are formed alternatively in the peripheral direction and each of the iron cores adjacent in the axial direction is disposed in a state that the convex portions of one iron core and the concave portions of an adjacent iron core face each other in the axial direction. Owing to this arrangement, the magnetic flux collectors and the main/sub iron cores are connected to each other without increasing the size.

Further, in each of the iron cores, a long pull-out groove for pulling out the coil wire to the outside is formed in the diameter direction and the pull-out groove is formed in a position formed with one of the concave portions. Owing to this arrangement, a portion of wiring which is free of interference between the magnetic flux collectors and the coil wire can be effectively used.

In the hub dynamo, each magnetic flux collector is an elongated plate member and the direction of the plate width of the plate member is oriented to the peripheral direction with respect to the iron cores and the sub iron cores. Owing to this arrangement, the size of the hub dynamo can be reduced.

Further, each magnetic flux collector is formed so that the cross-sectional area thereof becomes larger toward a connecting portion with at least one iron core. Owing to this arrangement, the magnetic flux from the magnets can be efficiently collected and the electric power can be stably supplied.

Additionally, each magnetic flux collector is formed so that the width of the plate becomes wider toward a connecting portion with at least one iron core. Owing to this arrangement, a high performance hub dynamo with a simple structure can be provided.

The sub iron cores of the hub dynamo are each formed of a plurality of laminated thin plate members. Owing to this arrangement, compared to the case where the sub iron core is formed of a single plate member, eddy current loss can be reduced and the sub iron core can be uniformly caulked with the magnetic flux collectors. Thus, efficiency in power generation of the hub dynamo is not reduced.

The main iron cores of the hub dynamo are each formed of a plurality of laminated thin plate members. Owing to this arrangement, compared to the case where the main iron core is formed of a single plate member, eddy current loss can be reduced and the main iron core can be uniformly caulked with the magnetic flux collectors. Thus, efficiency in power generation of the hub dynamo is not reduced.

### BRIEF DESCRIPTION OF THE DRAWINGS

The description of the exemplary embodiments will be made with reference to the drawings, in which:

FIG. 1 is a partial side view of a front wheel of a bicycle;

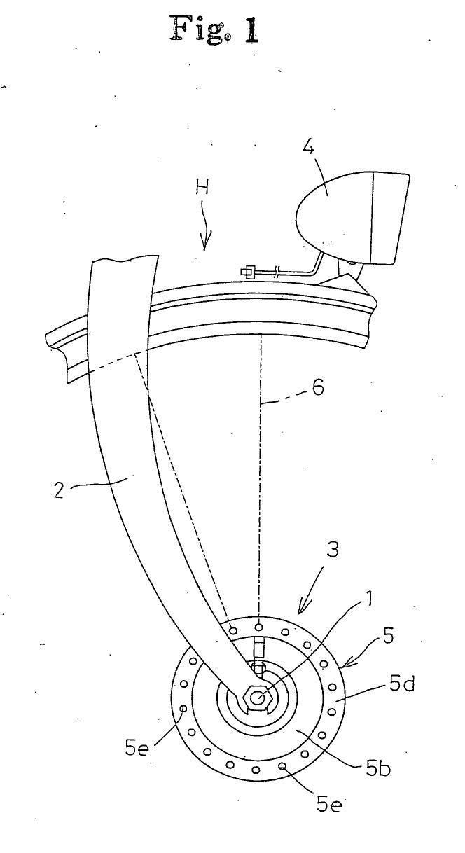

FIGS. 2(A) and 2(B) are a side view of a first iron core, and an exploded perspective view of components of a stator coil, respectively;

FIG. 3 is a front sectional view of a hub dynamo;

FIGS. 4(A) and 4(B) are front views in which a stator core is developed where FIG. 4(A) is a partial front view illustrating a first magnetized state, and FIG. 4(B) is a partial front view illustrating a second magnetized state, respectively;

FIG. 5 is a sectional view illustrating a magnetic path in the hub dynamo;

FIG. 6 is a front sectional view of a hub dynamo according to a second embodiment;

FIGS. 7(A) and 7(B) are a front view and a bottom view each showing a magnetic flux collector in a third embodiment;

FIGS. 8(A), 8(B) and 8(C) are a front view, a side view and a side view respectively of a stator in the third embodiment; and

FIG. 9 is a front view of a hub dynamo according to the third embodiment.

### DETAILED DESCRIPTION OF PREFERRED EMBODIMENTS

A first exemplary embodiment will be described below with reference to drawings. In the figures, reference numeral 1 denotes an axle constituting the rotational center of a front wheel H of a bicycle. The right and left ends of the axle 1 are supported by a pair of right and left front forks 2, and a hub dynamo 3 is disposed on the axle 1 between the right and left front forks 2.

Reference numeral 4 denotes a headlamp connected with the hub dynamo 3 so as to light up upon receiving the electric power from the hub dynamo 3.

Reference numeral 5 denotes a casing (hub) constituting the hub dynamo 3. The casing 5 comprises a cylindrical mainframe 5a, which is fitted over the axle 1 and a pair of right and left end brackets 5b disposed integrally in a state of covering the openings at the both ends of the cylinder in the axial direction of the main frame, or casing body, 5a. The end brackets 5b are each formed of a ring-like plate member, and attached to the axle 1 rotatably relative to the axle 1 via bearings 5c, which are provided on the outer circumference of a spacer 1a integrally fitted over the axle 1. The main frame 5a is further formed with collars 5d positioned at the both ends, in the axial direction, and protruding toward the outer diameter side. The collars 5d are formed with a plurality of through holes 5e in the peripheral direction thereof An inner end portion of spokes 6, part of the front wheel H, are integrally connected to the through holes 5e. Reference numeral 7 denotes come-out prevention members, which are provided to the outside of the both ends of a pair of right and left end brackets 5b in the axial direction.

On the inner circumference of the main frame 5a, a cylindrical yoke 8 is integrally disposed. For the inner circumference of the yoke 8, a plurality of pairs of permanent magnets 8a having an N-polarity and S-polarity, which are formed to be elongated in the axial direction and fixed in a state of being aligned in the peripheral direction are provided. Thus, the structure of the rotor of the hub dynamo 3 is formed.

In this embodiment, there are provided fourteen pairs; i.e., a total of twenty-eight permanent magnets 8a in a state that the magnetic polarity changes alternately. It is arranged so that, when the bicycle travels, the front wheel H rotates. The casing 5 (main frame 5a and end brackets 5b) rotates with respect to the axle 1 along with the front wheel H. As a result, the permanent magnets 8a on the inner circumference of the mainframe 5a rotate with respect to the axle 1.

On the other hand, a stator is provided along the portion of the axle 1 disposed within the casing 5. In that portion of the axle 1, a cylindrical pipe member 9, for reinforcing the axle 1 is integrally fitted over the axle 1. On both ends of the cylindrical pipe member 9, come-out prevention members 9a are provided. In this state, the pipe member 9 is positioned in the axial direction and come-out prevention measures are given thereto. Ring-like main iron cores 10, which are formed of a magnetic material, are fitted over the outer circumference at both ends of the pipe member 9 and a coil chamber CR is formed between the main iron cores 10. Further, the coil chamber CR is partitioned by at least one sub iron core 11 disposed between the main iron cores 10, thereby forming a plurality of coil chambers CR.

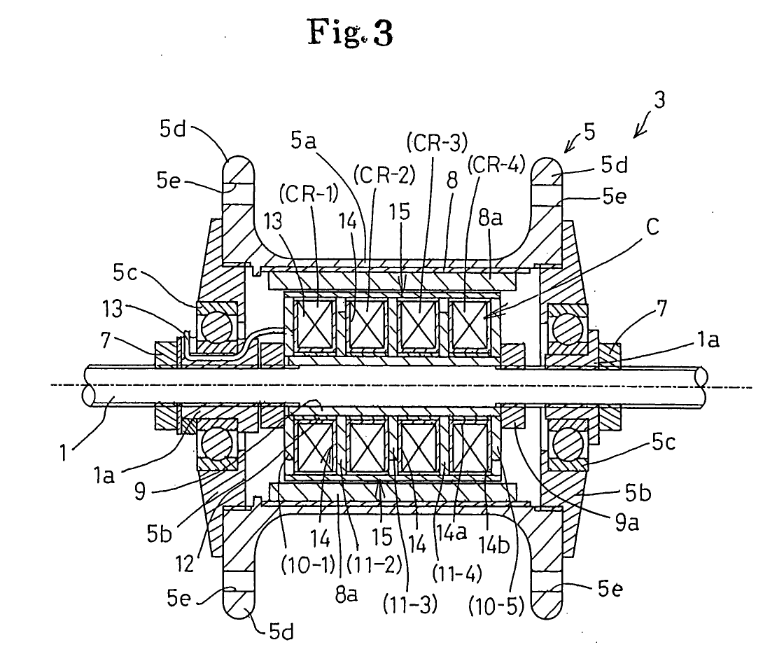

In this embodiment, as shown in FIG. 3, three sub iron cores 11 are provided between the main iron cores 10 in the axial direction to partition the outer circumference portion around the axle 1 (pipe member 9), thereby forming respectively a first, a second, a third and a fourth coil chambers CR-1, CR-2, CR-3, CR-4 from the left.

Reference numeral 12 denotes cylindrical bodies for connecting the inner diameter side edges between the adjacent main/sub iron cores 10, 11. The cylindrical bodies 12 are formed of a magnetic material, which form a magnetic path in the axial direction at the inner circumference side of the coil chambers CR-1, CR-2, CR-3, CR-4. However, when substituted with axle 1, the pipe member 9 and the cylindrical bodies 12 may not necessarily be provided.

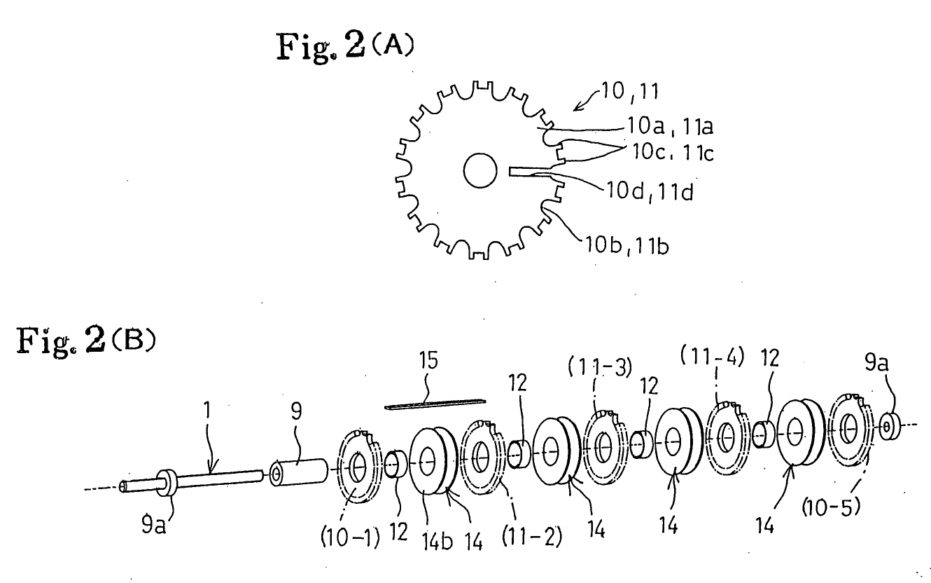

To assemble the stator, first, the come-out prevention member 9a is fitted over the axle 1 on one end in the axial direction (as shown on left side in the FIG. 2 (B)). Then, the cylindrical pipe member 9 is mounted on the axle 1 followed by a main iron core (10-1) inserted as a first iron core positioned at the one end side so as to abut against the come-out prevention member 9a. Then, a cylindrical body 12 is inserted so as to abut against the first main iron core 10-1. A coil bobbin 14, for winding coil wire 13, is fitted over the outer circumference of the cylindrical body 12 to form a first coil chamber CR-1. The coil bobbin 14 comprises a cylindrical portion 14a, which is fitted over the cylindrical body 12, and a flange 14b extending toward the outer diameter side at each end of the cylindrical portion 14a.

Next, a sub iron core 11-2, which is disposed between the main iron cores 10, is inserted as the second iron core. It is arranged so that, the second sub iron core 11-2 is inserted so as to abut against the coil flange portion 14b of the first coil chamber CR-1. Then, using the same assembling procedure as described above, a cylindrical body 12 for the second coil chamber CR-2, a coil bobbin 14, a sub iron core 11-3 as a third iron core, a cylindrical body 12 for the third coil chamber CR-3, a coil bobbin 14, a sub iron core 11-4 as a fourth iron core, a cylindrical body 12 for a fourth coil chamber CR-4, a coil bobbin 14, and a main iron core 10-5 as a fifth iron core are inserted in that order. Finally, the come-out prevention member 9a is inserted onto the other end of the axle 1 in the axial direction.

Then, one coil wire 13 is continuously wound on the four coil bobbins 14 attached as described above, to form a coil C. On the coil bobbin 14 of the first coil chamber CR-1, the coil wire 13 is wound in a predetermined winding direction; on the coil bobbin 14 of the second coil chamber CR-2, the coil wire is wound in a winding direction opposite the above predetermined winding direction; then on the coil bobbin 14 of the third coil chamber CR-3, the coil wire is wound in the same, or predetermined, winding direction as that on the coil bobbin 14 of the first coil chamber CR-1; and then on the coil bobbin 14 of the fourth coil chamber CR-4, the coil wire is wound in the same, or opposite to the predetermined, winding direction as that on the coil bobbin 14 of the second coil chamber CR-2. As a result, the coil wire 13 is wound on the respective coil bobbins 14 in winding directions opposite each other.

In the above-described attached state, the dimension of the main/sub iron cores 10, 11 is set so that the outer diameter thereof is larger than the outer diameter of the coil bobbin 14. On the peripheral edge of the main/sub iron cores 10, 1, convex portions 10a, 11a are formed at fourteen points at the same intervals in the peripheral direction. By forming the convex portions 10a, 11a, concave portions 10b, 11b are alternately formed at fourteen points at a (360/28)° pitch between the adjacent convex portions 10a, 11a in the peripheral direction. Further, on the outer end of the convex portions 10a, 11a, a pair of opposing projecting pieces 10c, 11c are formed in the peripheral direction respectively. The first main iron core 10-1, which is positioned at one end of the hub dynamo 3 in the axial direction, the third sub iron core 11-3 and the fifth main iron core 10-5, which is positioned at the other end in the axial direction, are disposed in such positioning that the projecting pieces 10c, 11c take the same (synchronous) position as each other in the peripheral directions. The positions of the projecting pieces 11c of the second sub iron core 11-2 and the fourth sub iron core 11-4 in the peripheral direction are positioned opposite the concave portions 10b, 11b of the first main iron core 10-1, the third sub iron core 11-3 and the fifth main iron core 10-5, that is, the projecting pieces 11c of the second sub iron core 11-2 and the fourth sub iron core 11-4 are displaced in the peripheral direction by an angle of (360/28)° (1 pitch angle) with respect to the respective projecting pieces 11c of the first main iron core 10-1, the third sub iron core 11-3, and the fifth main iron core 10-5.

Reference numerals 10d, 11d denote a pull-out groove for guiding the coil wire 13 wound on each coil bobbin 14 to the adjacent coil bobbin 14.

On the outer circumference of the coil C assembled as described above, a plurality of magnetic flux collectors 15, for collecting magnetic flux by receiving magnetic polarity from the permanent magnets 8c on the inner circumference of the yoke 8, are disposed in parallel with each other in the peripheral direction. The magnetic flux collectors 15 are formed of a long plate member of a magnetic material. Twenty-eight collectors are so disposed, the same number as that of the permanent magnets 8a. The plate of the magnetic flux collectors 15 is set to have a length from the first main iron core 10-1 to the fifth main iron core 10-5 facing the first to fourth coil chambers CR-1, CR-2, CR-3, CR-4. The width of the magnetic flux collectors 15 is set to be larger than the thickness of the plate and formed to have substantially the same dimension of the facing gap between the main/sub iron core projecting pieces 10c, 11c on the same convex portion 10a, 11a in the peripheral direction. The magnetic flux connectors 15 are fixed to the projecting pieces 11c by means of caulking.

Here, as described above, the projecting pieces 10c, 11c of the first, third and fifth iron cores 10-1, 11-3, 10-5 and the projecting pieces 11c of the second and the fourth iron cores 11-2, 11-4 are positioned at the same position in the peripheral direction. Further, the projecting pieces 10c, 11c are disposed in a state of being displaced by one pitch angle of each other. Therefore, for example, assuming that a magnetic flux collector 15 at an arbitrary position in the peripheral direction is the first magnetic flux collector 15-1 (equivalent to the first magnetic flux collector in the exemplary embodiments), it is arranged so that, when the first magnetic flux collector 15-1 is fixed by caulking to the iron cores of every other iron core from the first iron core 10-1 as a reference; i.e., to the projecting pieces 10c, 11c of the first, third and fifth iron cores 10-1, 11-3, 10-5, the second magnetic flux collector 15-2 (equivalent to the second magnetic flux collector in the exemplary embodiments) adjacent to the first magnetic flux collector 15-1 is fixed by caulking to the iron cores other than the first, third, fifth iron cores 10-1, 11-3, 10-5; i.e., to the projecting pieces 11c of the second, fourth iron cores 11-2, 11-4. As a result, the first to 28th magnetic flux collectors 15-1 to 15-28 are disposed so that the first magnetic flux collector 15 is fixed by caulking to connect (joined) to the first, third and fifth iron cores 10-1, 1I1-3, 10-5 and positioned closer to a permanent magnet 8a of one magnetic polarity facing thereto to be magnetized, and the second magnetic flux collector 15 is connected (joined) to the second and fourth iron cores 11-2, 11-4 and positioned closer facing a permanent magnet 8a of the other magnetic polarity to be magnetized. Accordingly the first magnetic flux collector 15 and the second magnetic flux collector 15 are disposed alternately in the peripheral direction. Further, the iron cores 10, 11 connected to the magnetic flux collectors 15 are arranged so that the adjacent iron cores 10, 11 are magnetized to a polarity different from each other.

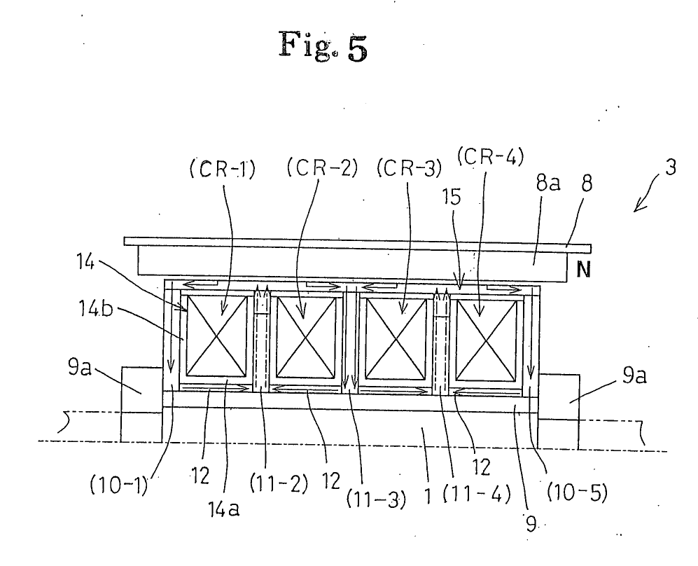

In the stator structured as described above, each of the coil chambers CR-1, CR-2, CR-3, CR-4 is enclosed by the magnetic flux collectors 15, the main and sub iron cores 10, 11 and the cylindrical body 12. The stator is arranged so that the magnetic flux, which is collected by a magnetic flux collector 15, flows to a magnetic flux collector 15 through a magnetic path formed in the diameter direction by the main/sub iron cores 10, 11, an inner diameter portion magnetic path in the axial direction formed by the cylindrical body 12 and a magnetic path in the diameter direction formed by the main/sub iron cores 10, 11 adjacent to the main/sub iron cores 10, 11. With this arrangement, magnetic paths for the adjacent coil chambers CR-1, CR-2, CR-3, CR-4 partitioned by the sub iron cores 11 are formed by the sub iron cores 11 therebetween. Thus, the sub iron cores 11 are arranged so as to share the magnetic paths for the adjacent coil chambers CR-1, CR-2, CR-3, CR-4 (FIG. 5).

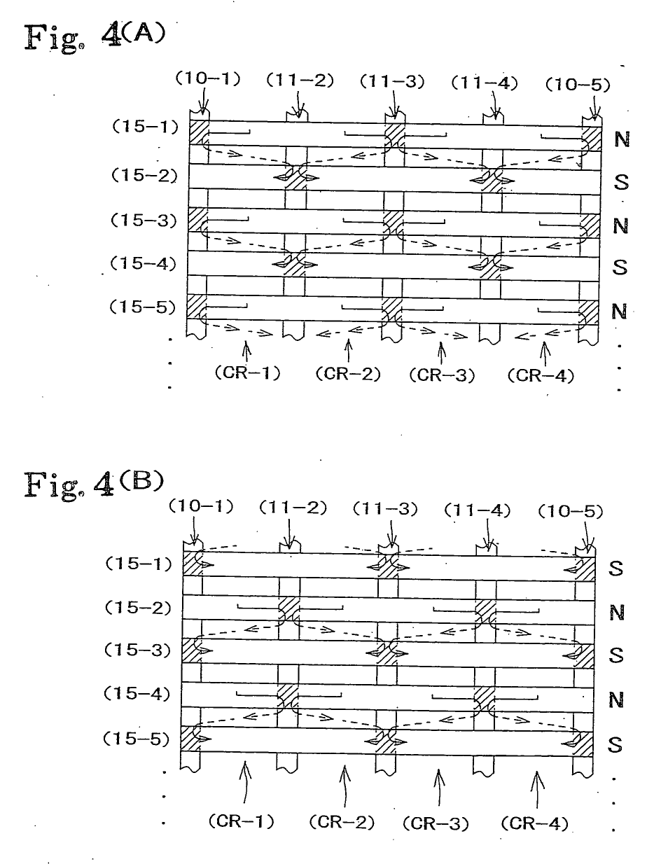

In the hub dynamo 3 structured as described above, when the casing 5 rotates, the 14-pair permanent magnets 8a, which are provided on the inner circumference of the yoke 8, rotate respectively with respect to the coil C formed by the coil wire 13, which is wound in each of the first to fourth coil chambers CR-1, CR-2, CR-3, CR-4 enclosed by the magnetic flux collectors 15, the main/sub iron cores 10, 11 and the cylindrical body 12. Accompanying this, electric power is generated in the coil wire 13 in each coil chamber CR-1, CR-2, CR-3, CR-4, thus the electric power is generated in the coil C. The mechanism of generation of the electric power will be described with reference to a developed view of the stator shown in FIG. 4 and a sectional view of the stator shown in FIG. 5.

The elongated plate magnetic flux collectors 15 are arranged so as, when the yoke 8 rotates along with the casing 5 in accordance with rotation of the front wheel H, accompanying the rotation by one pitch angle, to face the permanent magnets 8a which are magnetized to N-polarity and S-polarity alternately.

As illustrated in FIG. 4(A), it is arranged so that, when the first magnetic flux collector 15-1 faces a permanent magnet 8a with N-polarity and is connected to each of the first, third and fifth iron cores 10-1, 11-3, 10-5, the second magnetic flux collector 15-2 faces a permanent magnet 8a with S-polarity and is connected to the second and fourth iron cores 11-2, 11-4. In this case, the first, third and fifth iron cores 10-1, 11-3, 10-5 are magnetized to N-polarity; and the second and fourth iron core 11-2, 11-4 are magnetized to S-polarity, that is, a first magnetized state is caused.

In this state, as shown in FIG. 4(A) or FIG. 5, a counterclockwise magnetic path (refer to FIG. 5) is respectively formed around the first or third coil chamber CR-1, CR-3 from the first or third iron cores 10-1, 11-3 connected to the first magnetic flux collector 15-1, which is magnetized to N-polarity to the second or fourth iron core 11-2, 11-4 via the cylindrical body 12. Thus, magnetic flux of negative direction flows through the first or third coil chamber CR-1, CR-3.

On the other hand, a clockwise magnetic path (refer to FIG. 5) is respectively formed around the second or fourth coil chamber CR-2, CR-4 from the third or fifth iron core 11-3, 10-5 connected to the first magnetic flux collector 15-1 magnetized to N-polarity to the second or fourth iron core 11-2, 11-4 via the cylindrical body 12. As a result, magnetic flux of positive direction flows to the second or fourth coil chamber CR-2, CR-4.

Contrary to this, in a state that a rotation has been made by one pitch angle from the above described state, as shown in FIG. 4(B), the first magnetic flux collector 15-1 faces a permanent magnet 8a with S-polarity, and is connected to the first, third and fifth iron cores 10-1, 11-3, 10-5, the second magnetic flux collector 15-2 faces a permanent magnet 8a with N-polarity, and is connected to the second and fourth iron cores 11-2, 11-4. Here, the first, third and fifth iron cores 10-1, 11 -3, 10-5 are magnetized to S-polarity, and the second and fourth iron cores 11-2, 11-4 are magnetized to N-polarity, that is, a second magnetized state is caused. In this state, as shown in FIG. 4(B), around the first or third coil chamber CR-1, CR-3, a clockwise magnetic path is respectively formed from the second or fourth iron core 11-2, 11-4 connected to the second magnetic flux collector 15-2, which is magnetized to N-polarity, to the first or third iron core 10-1, 11-3 via the cylindrical body 12. As a result, a magnetic flux of positive direction flows through the first or third coil chamber CR-1, CR-3.

On the other hand, around the second or fourth coil chamber CR-2, CR-4, a counterclockwise magnetic path is respectively formed from the second or fourth iron core 11-2, 11-4 connected to the second magnetic flux collector 15-1, which is magnetized to N-polarity, to the third or fifth iron core 11-3, 10-5 via the cylindrical body 12. As a result, a magnetic flux of negative direction flows to the second or fourth coil chamber CR-2, CR-4.

As described above, when the first magnetized state and the second magnetized state are repeated alternately, electric power is generated on the coil wire 13 in the first to fourth coil chambers CR-1, CR-2, CR-3, CR-4. In this case, the coil wire 13 in the coil chambers CR-1, CR-2, CR-3, CR-4 continues in a state that the winding direction of the single coil wire 13 changes alternately. As a result, the electric power generated on the coil C is obtained in a state having a high voltage.

In the embodiment of the exemplary embodiment constituted as described above, the coil C constituting the hub dynamo 3 is composed of the coil wire 13, which is wound in the first to fourth coil chambers CR-1, CR-2, CR-3, CR-4 partitioned by the sub iron cores 11. The magnetic flux collectors 15 are not constituted of a claw pole type, but constituted of long plate members supported by the main/sub iron cores 10, 11. In the coil C constituted of the coil wire 13 wound in each of the coil chambers CR-1, CR-2, CR-3, CR-4, the electric power is generated on each coil chamber CR-1, CR-2, CR-3, CR-4, and in the middle portion of the long magnetic flux collectors 15 disposed between the main iron cores 10, sub iron cores 11 are connected thereto to reduce the distance of the magnetic path. Therefore, the loss can be reduced and the efficiency in power generation can be increased.

Further, the magnetic flux collectors 15, which have a length equivalent to the full length of the stator (extend between the facing main iron cores 10), are disposed in parallel to each other in the peripheral direction. Therefore, the gaps between the magnetic flux collectors 15 can be uniformly maintained in any portion in the longitudinal direction of the stator. Further, because the magnetic flux connectors 15 are connected with the iron cores 10, 11 and supported thereby, sufficient supporting strength can be obtained. Accordingly, the stator can be constructed with multipolarity without increasing the outer diameter of the stator and a resulting light weight and compact structure can be achieved without changing the efficiency in power generation. Not only is such superior in design, but also electric power can be generated with a light load while traveling on a bicycle.

Furthermore, in this embodiment, even when the gap between the permanent magnets 8a and the magnetic flux collectors 15 varies depending on the position of the connection portion between the magnetic flux collectors 15 and the respective iron cores 10, 11, or the connection is insufficient due to a dimensional error of the magnetic flux collectors 15, a warp of the magnetic flux collectors 15, dimensional error of the respective iron cores 10, 11 or the like, the magnetic flux collectors 15 face the permanent magnets 8a in a state extending in full length of the stator to balance the magnetic flux in the longitudinal direction. Further, because the plurality of long first and second magnetic flux collectors 15 are arranged so as to connect respectively on the outer circumference of the iron cores 10, 11, which have the same polarity, the magnetic paths for the coil chambers CR-1, CR-2, CR-3, CR-4 are shared by the adjacent chambers. Therefore, the magnetic flux generated is well balanced in the coil chambers CR-1, CR-2, CR-3, CR-4. Accordingly, a high performance hub dynamo is achieved capable of functioning without decreasing the efficiency in power generation.

Further, the hub dynamo 3 according to the embodiment is structured so that the magnetic flux collectors 15 are connected with the corresponding main and sub iron cores 10, 11 to be supported thereby. Therefore, as the connection portions between the magnetic flux collectors 15 and the main/sub iron cores 10, 11, the first magnetic flux collector 15 has three connection points; the second magnetic flux collector 15 has two connection points. Accordingly, the magnetic saturation can be reduced and the magnetic flux collectors 15 can be stably supported.

Still further, in this case, between the respective coil chambers CR-1, CR-2, CR-3, CR-4, are positioned the second, third and fourth iron cores 11-2, 11-3, 11-4. The second, third and fourth iron cores 11-2, 11-3, 11-4 serve as the magnetic paths for the adjacent coil chambers CR. Therefore, the component members can be shared therebetween resulting in a reduction in the number of the component parts, simplification of the structure and, further, a cost reduction. Furthermore, the structure is such that one coil wire 13 is pulled out to the adjacent coil chamber CR through the pull out grooves 10d, 11d. Therefore, the coil wire 13 does not have to be provided separately for each coil chamber CR. Accordingly, the structure can be further simplified and is more compact.

Further, in this embodiment, the magnetic flux collectors 15 and the main/sub iron cores 10, 11 are connected with each other by fixing in a manner of caulking using the projecting pieces 10c, 11c formed on the main/sub iron cores 10, 11. Therefore, the magnetic flux collectors 15 and the main/sub iron cores 10, 11 can be formed by press working resulting in a further cost reduction.

Also, in this embodiment, each of the main/sub iron cores 10, 11 are formed with the convex portions 10a, 11a and the concave portions 10b, 11b alternately. Using the convex portions 10a, 11a, the magnetic flux collectors 15 are connected; and using the concave portions 10b, 11b, the connected magnetic flux collectors 15 can be recessed. Therefore, the hub dynamo is prevented from becoming larger in size.

Additionally, the main/sub iron core 10, 11 is formed with the pull-out groove 10d, 11d for pulling out the coil wire 13 to the adjacent coil chamber CR or to the outside. Because the pull-out groove 10d, 11d is formed in a portion where the concave portion of the main/sub iron cores 10b, 11b face each other, the wiring can be effectively made using a portion where the magnetic flux collectors 15 and the coil wire 13 do not interfere with each other. As a result, efficiency in assembly work of the magnetic flux collectors 15 can be increased.

Further, in this embodiment, the magnetic flux collectors 15 are fixed in a manner of caulking in a state that the plate width direction is oriented to the peripheral direction of the main/sub iron cores 10, 11 with respect to the main/sub iron cores 10, 11. Therefore, the size of the hub dynamo can be further reduced and made more compact.

As a matter of course, the disclosure is not limited to the above-described embodiment. Unlike the just described exemplary embodiment, the number of the coil chambers formed at the axle side is not limited to four. A structure having an appropriate number of chambers (2, 3, 5, 6 . . . ) may be created. In this case also, by using a structure in which only one coil wire is wound in the coil chambers and the winding direction is changed alternately, a high voltage electric power can be generated the same as in the case of the above described exemplary embodiment. Further, the number of permanent magnets is not limited to fourteen pairs; or the number of pole pieces is not limited to twenty-eight. In accordance with the need, such as required voltage or the like, an appropriate number of coils and magnetic poles can be selected.

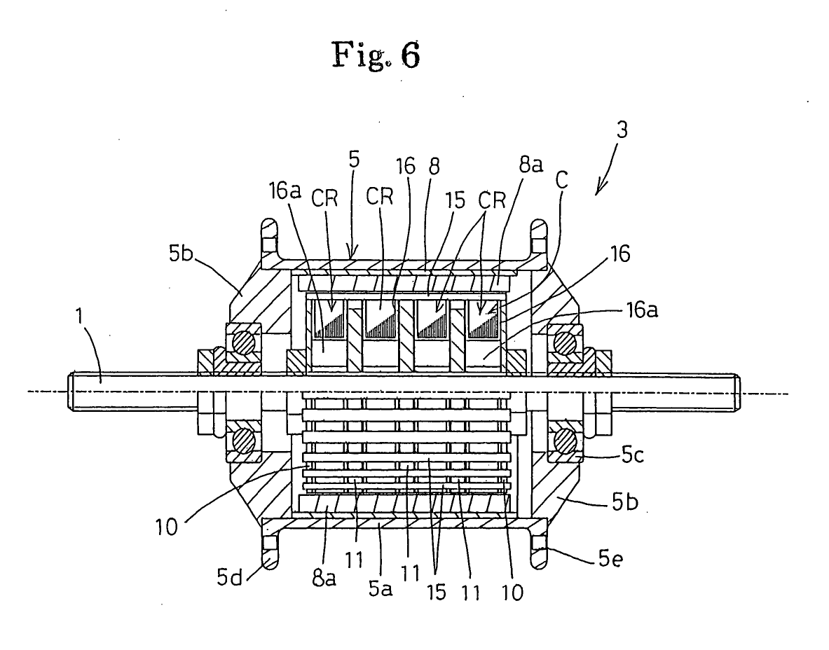

Next, a second exemplary embodiment will be described with reference to FIG. 6. In this embodiment, spacer portions 16a are formed on the inner diameter portion of the coil bobbin 16 so as to displace the coil chamber CR toward the outer diameter side of the hub dynamo 3.

Further, unlike the above first embodiment, the sub iron cores 11 are not formed of one plate member, but may be formed by laminating a plurality of thin plate members. In this case, compared to the iron core 11 having a single plate member, eddy current loss can be reduced. As a result, the efficiency in power generation can be prevented from being reduced. Additionally, when fixing the magnetic flux collectors to the sub iron cores 11 by a manner of caulking, the fixing force at the fixing portions can be made uniform Thus, a highly reliable hub dynamo 3 can be obtained. Further, the main iron cores 10 can also be formed by laminating a plurality of thin plate members, the same as the sub iron cores 11. In this case also, the same effects can be obtained.

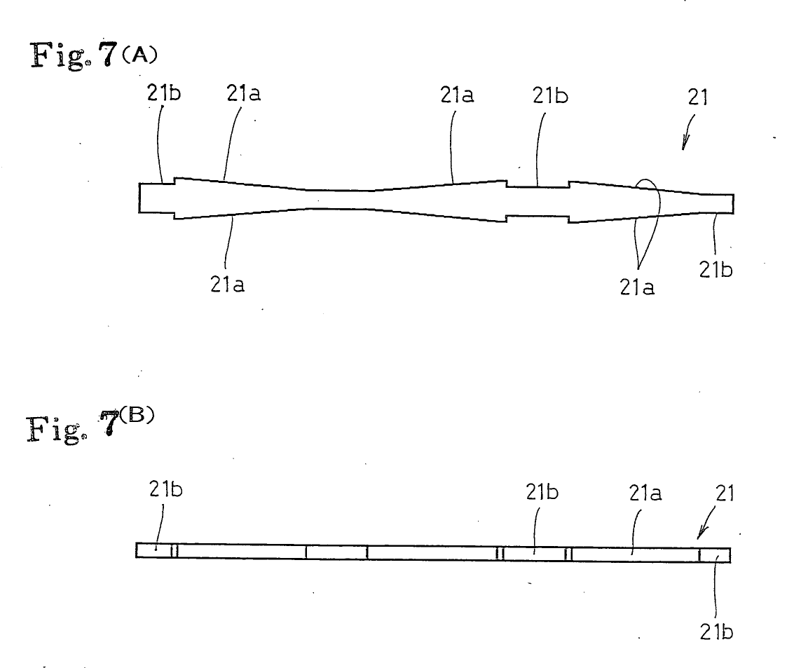

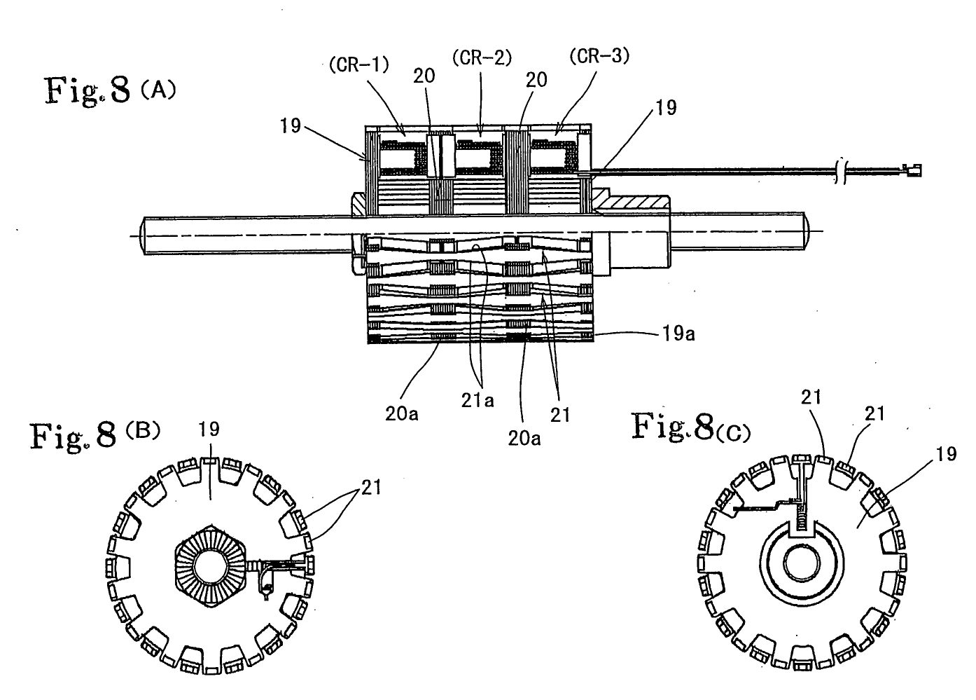

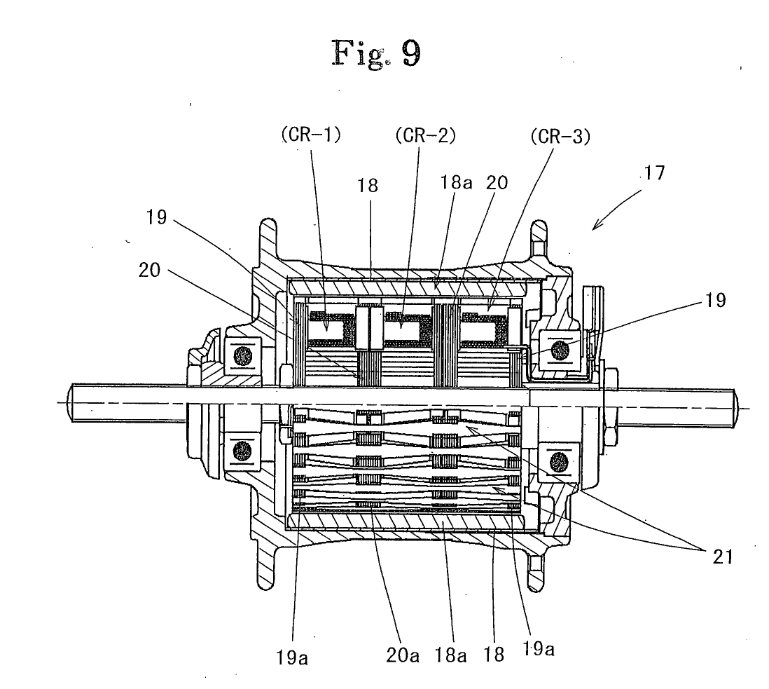

Also, an arrangement according to a third exemplary embodiment as shown in FIGS. 7 to 9 is possible. In a hub dynamo 17 according to this third embodiment, the basic structure is the same as that of the above-described embodiments. That is, 14-pair of permanent magnets 18a are provided to the inner circumference of the yoke 18. Between the main iron cores 19 facing each other, two sub iron cores 20 are provided to form first to third coil chambers CR-1, CR-2, CR-3. In this embodiment, the main/sub iron cores 19, 20 are constructed of a plurality of laminated plate members 19a, 20a to increase the efficiency in power generation. Further, in this embodiment, the same as in the case of the above-described circumference of the respective iron cores 19, 20, are connected to the adjacent iron cores 19, 20 so as to be magnetized to a polarity different from each other. Here, the magnetic flux collectors 21 are provided with inclined (tapered) portions 21a and narrower portions 21b. Inclined portions 21a are formed to be wider adjacent the connection portions with the main/sub iron cores 19, 20, and narrower portions 21b are formed at the connection portions with the iron cores 19, 20 having a predetermined width. Owing to this, it is arranged so that, when connected with the main/sub iron cores 19, 20 being fixed by a manner of caulking, the cross-sectional area of the magnetic flux collector 21 of the connection portion vicinity is formed larger. Owing to this arrangement, the amount of magnetic flux from the iron cores 19, 20 can be effectively collected in the magnetic flux collector 21. Thus, the efficiency in power generation can be further increased and the electric power can be supplied stably.

As described above, the hub dynamo according to the exemplary embodiments is useful as the electric power source for lighting the headlamp of a bicycle. In particular, the hub dynamo can be made compact while reducing the loss in the generation of electric power. Therefore, the hub dynamo increases the efficiency in power generation and is suitable for use as an electric power generator for bicycles.

1. A hub dynamo for a bicycle, having a stator and a rotor, the stator fixed to the axle side comprising:
a pair of main iron cores, each formed of a ring-like plate member, disposed at the stator ends to form a coil chamber therebetween;
at least one sub iron core formed of a ring-like plate member and disposed between the pair of main iron cores to partition the coil chamber, the main iron cores and the at least one sub iron core making up a set of iron cores;
a coil wire wound in the partitioned coil chambers; and
magnetic flux collectors formed of an elongated member extending between the main iron cores, disposed in parallel with each other in the peripheral direction on the outer circumference of the iron cores, the magnetic flux collectors closely facing elongated permanent magnets aligned and disposed on the inner circumference of the rotor at the wheel side in a state that the magnetic polarity changes alternately in the peripheral direction,
wherein a first magnetic flux collector of the magnetic flux collectors facing one magnetic polarity and a second magnetic flux collector facing the other magnetic polarity are connected to respective iron cores so as to magnetize adjacent iron cores to an opposite polarity from each other.

2. A hub dynamo for a bicycle, having a stator and a rotor, the stator fixed to axle side comprising:
a pair of main iron cores, each formed of a ring-like plate member, disposed at the stator ends to form a coil chamber;
at least one sub iron core formed of a ring-like plate member and disposed between the pair of main iron cores to partition the coil chamber, the main iron core and the at least one sub iron core making up a set of iron cores;
a coil wire wound in the partitioned coil chambers; and
magnetic flux collectors formed of an elongated member extending between the main iron cores, disposed in parallel with each other in the peripheral direction on the outer circumference of the iron cores, which closely face elongated permanent magnets disposed on the inner circumference of the rotor at the wheel side in a state that the magnetic polarity changes alternately in the peripheral direction,
wherein a first magnetic flux collector of the magnetic flux collectors facing one magnetic polarity and a second magnetic flux collector facing the other magnetic polarity are connected to the respective iron cores so as to magnetize the adjacent iron cores to an opposite polarity from each other,
magnetic paths for the adjacent coil chambers partitioned by the at least one sub iron core are formed by the at least one sub iron core.

3. The hub dynamo according to claim 1, wherein the first magnetic flux collector is connected to the main iron core at one end side of the axle and to every other iron core moving away from the side main iron core,
the second magnetic flux collector is connected to the iron cores unconnected to the first magnetic flux collector.

4. The hub dynamo according to claim 1, wherein the coil wire wound in each coil chamber is arranged so that the directions of the winding wires in adjacent coil chambers are opposite each other.

5. The hub dynamo according to claim 1, wherein the coil wire wound in each coil chamber is continuously wound in order from the coil chamber at the end side in the axial direction.

6. The hub dynamo according to claim 1, wherein the magnetic flux collectors are fixed to projecting pieces formed on the outer circumference of each iron core by means of caulking.

7. The hub dynamo according to claim 6, wherein, on the outer circumference of each iron core, concave portions and convex portions are formed alternatively in the peripheral direction and each of the iron cores adjacent in the axial direction is disposed in a state that the convex of one iron core and the concave portion portions of an adjacent iron core face each other in the axial direction.

8. The hub dynamo according to claim 7, wherein, in each of the iron cores, a pull-out groove for pulling out the coil wire to the outside is formed to be elongated in the diameter direction and the pull-out groove is formed in a position formed with one of the concave portions.

9. The hub dynamo according to claim 1, wherein each magnetic flux collector is an elongated plate member and the width of the plate member faces to the peripheral direction of the main iron cores and sub iron cores.

10. The hub dynamo according to claim 9, wherein the each magnetic flux collector is formed so that the cross-sectional area thereof becomes larger toward a connecting portion with at least one iron core.

11. The hub dynamo according to claim 9, wherein the each magnetic flux collector is formed so that the width of the plate becomes wider toward a connecting portion with at least one iron core.

12. The hub dynamo according to claim 1, wherein the sub iron is cores are formed of a plurality of laminated thin plate members.

13. The hub dynamo according to claim wherein the main iron is cores are each formed of a plurality of laminated thin plate members.

14. The hub dynamo according to claim 2, wherein the first magnetic flux collector is connected to the main iron core at one end side of the axle and to every other iron core moving away from the side main iron core,
the second magnetic flux collector is connected to the iron cores unconnected to the first magnetic flux collector.

15. The hub dynamo according to claim 14, wherein the coil wire wound in each coil chamber is arranged so that the directions of the winding wires in adjacent coil chambers are opposite each other.

16. The hub dynamo according to claim 14, wherein the coil wire wound in each coil chamber is continuously wound in order from the coil chamber at the end side in the axial direction.

17. The hub dynamo according to claim 14, wherein the magnetic flux collectors are fixed to projecting pieces formed on the outer circumference of each iron core by means of caulking.

18. The hub dynamo according to claim 15, wherein each magnetic flux collector is an elongated plate member and the width of the plate member faces to the peripheral direction of the main iron cores and sub iron cores.

19. The hub dynamo according to claim 2, wherein the sub iron cores are formed of a plurality of laminated thin plate members.

20. The hub dynamo according to claim 2, wherein the main iron cores are each formed of a plurality of laminated thin plate members.
